(19) United States
(12) Patent Application Publication
(10) Pub. No.: US 2022/0377088 A1
(43) Pub. Date: Nov. 24, 2022

(54) DATA MANAGEMENT COMPUTER AND DATA MANAGEMENT METHOD

(71) Applicant: Hitachi, Ltd., Tokyo (JP)

(72) Inventors: Keiichi MATSUZAWA, Tokyo (JP); Mitsuo HAYASAKA, Tokyo (JP)

(21) Appl. No.: 17/641,826

(22) PCT Filed: Nov. 20, 2020
(86) PCT No.: PCT/JP2020/043514

§ 371 Date: Mar. 10, 2022

(30) Foreign Application Priority Data
Dec. 23, 2019 (JP) 2019-231943

(51) Int. Cl. H04L 9/40

(52) U.S. Cl. CPC H04L 63/1416

(57) ABSTRACT

There is provided a data management apparatus that detects data leakage of confidential information in a data processing process before working and conversion processing of data are performed. The data management apparatus is connected to a flow creation computer that creates a data processing flow, a data lake that stores various types of data, and a flow execution computer that executes the data processing flow. The data management apparatus specifies a data attribute of output data of a first node indicated in the received data processing flow, specifies pre-processing to be executed on data, based on the specified data attribute and an access control table for managing the pre-processing to be executed for the data attribute, and determines an access violation by determining whether the specified pre-processing coincides with a processing content of the data processing flow.

### BACKGROUND OF THE INVENTION

### 1. Field of the Invention

The present invention relates to a technique for determining an access violation of a data processing flow.

### 2. Description of the Related Art

With the progress of a cloud technique, data utilization in a hybrid cloud configuration in which a public cloud and a private cloud constructed by a company are linked has progressed. In the hybrid cloud, optimal data utilization is performed by selectively using the public cloud and the private cloud in accordance with characteristics of data, data processing, and computer resources. For example, in a distributed base, a use method in which primary working of data is executed in a private cloud constructed in each base, and a public cloud is used for secondary working of collecting pieces of data in all bases because the secondary processing requires computer resources can be considered.

In such a complicated configuration, as a technique for easily designing data processing, there is a technique for creating data processing as a flow. In this technology, an input/output destination of data and individual processing (referred to as a “service” below) of working and converting data, in each cloud, are defined as a data processing flow. For example, a creator of the data processing flow connects nodes representing services with a directed edge on a graphical user interface (GUI) to create a working order of data as a flow. An execution unit of the data processing flow calls each service in accordance with the order of the data processing flow to perform an instruction of data working or define an input/output destination of data, thereby proceeding with data processing.

At this time, when the services operating in different clouds in the flow are connected by the directed edge, there is a possibility that a data processing execution unit performs an instruction to move data between the clouds.

In recent years, demands for data control on personal information and confidential information of companies have been strengthened by laws and regulations, and, regarding data movement between clouds, it is required that confidential information such as personal information is not inattentively leaked. U.S. Pat. No. 10,178,070 discloses a technique for preventing leakage of confidential information between a plurality of services.

U.S. Pat. No. 10,178,070 discloses a technique in which services are divided into groups in advance, a communication content is monitored for communication across the groups, and leakage of confidential information is detected. Although U.S. Pat. No. 10,178,070 realizes prevention of leakage of confidential information, there remains a problem in the case of application to a data processing flow. That is, when a data processing flow in which multiple services are connected is created and executed, and leakage of confidential information is detected at the end of the flow execution, leakage of confidential information is performed, and then is detected at the end of the flow execution. Therefore, the computer resources and the time of the data processing flow execution unit, which are taken to the data processing until the leakage of the confidential information is detected are wasted.

In creation of a data processing flow, it is generally necessary to create and execute a flow many times for trial and error of the processing order and parameters. In U.S. Pat. No. 10,178,070, since data is leaked, the turnaround time until it is found to be unexecutable becomes long, and the efficiency of trial and error decreases. In addition, the utilization efficiency of the computer resources for executing the data processing flow decreases, and the energy for executing the data processing flow is also wastefully consumed.

### SUMMARY OF THE INVENTION

An object of the present invention is to provide a data management computer and a data management method for detecting a possibility of data leakage of confidential information in a data processing process, before working and conversion processing of data are performed.

In order to solve the above problem, according to an aspect of the present invention, a data management computer is connected to a flow creation computer that creates a data processing flow indicated by an arrangement of nodes that execute services, a data lake that stores various types of data, and a flow execution computer that executes the data processing flow, and detects an access violation of the data processing flow. Therefore, the data management computer includes a memory that stores an access control table for managing pre-processing to be executed for a data attribute for data of a data processing flow, an interface that receives the data processing flow from the flow creation computer, and a processing unit that specifies a data attribute of output data of a first node indicated in the received data processing flow, specifies pre-processing to be executed for the specified data attribute based on the data attribute and the access control table, determines an access violation by determining whether the specified pre-processing coincides with a processing content of the data processing flow, performs control so as to transmit the data processing flow to the flow execution computer when there is no access violation, and so as not to transmit the data processing flow to the flow execution computer when there is the access violation.

According to the present invention, it is possible to detect a possibility of data leakage of confidential information, before working and conversion processing of data are started.

### BRIEF DESCRIPTION OF THE DRAWINGS

FIG. 1 is a configuration diagram illustrating a computer system to which the present invention is applied, in a first embodiment;

FIG. 2 is a diagram illustrating a data processing flow and an interface of a screen for creating and editing the data processing flow, in the first embodiment;

FIG. 3 is a configuration diagram illustrating a data management computer in the first embodiment;

FIG. 4 is a configuration diagram illustrating a flow execution computer in the first embodiment;

FIG. 5 is a configuration diagram illustrating an internal service providing computer in the first embodiment;

FIG. 6A is a configuration diagram illustrating a data lake computer in the first embodiment;

FIG. 6B is a diagram illustrating an example of structured data stored in the data lake computer in the first embodiment;

FIG. 7 illustrates a configuration example of a data attribute management table in the first embodiment;

FIG. 8 illustrates a configuration example of an access control table in the first embodiment;

FIG. 9 illustrates a configuration example of a service characteristic table in the first embodiment;

FIG. 10A illustrates a processing flow of data processing execution in the first embodiment;

FIG. 10B illustrates a processing flow of detecting an access violation of the data processing flow in the first embodiment;

FIG. 11 is a diagram illustrating an analysis example of the processing flow of the data processing execution in the first embodiment;

FIG. 12 is a diagram illustrating an analysis example of a processing flow of data processing execution in a second embodiment;

FIG. 13 illustrates a processing flow of data processing execution in a third embodiment;

FIG. 14 is a diagram illustrating an analysis example of a processing flow of the data processing execution in the third embodiment; and

FIG. 15 illustrates a processing flow of data processing execution in a fifth embodiment.

### DESCRIPTION OF THE PREFERRED EMBODIMENTS

In the following description, a “processing unit” refers to one or more processors. At least one processor is typically a microprocessor such as a central processing unit (CPU), but may be another type of processor such as a graphics processing unit (GPU). At least one processor may be a single core or a multi-core.

At least one processor may be a processor in a broad sense, such as a hardware circuit (for example, a field-programmable gate array (FPGA) or an application specific integrated circuit (ASIC)), that performs a part or the entirety of processing.

In addition, in the following description, information for obtaining an output with respect to an input will be described by an expression such as “xxx table”, but this information may be data of any structure, or may be a learning model, such as a neural network, that generates an output with respect to an input. Thus, the “xxx table” can be referred to as “xxx information”.

In the following description, the configuration of each table is an example, and one table may be divided into two or more tables, or all or some of two or more tables may be made to be one table.

Furthermore, in the following description, processing may be described with a “program” as a subject, but the subject of the processing may be set to a processor unit (alternatively, a device such as a controller having the processor unit) because the processor unit executes the program to perform defined processing by appropriately using a storage unit and/or an interface unit, for example.

The program may be installed on a device such as a computer, or may be, for example, on a program distribution server or a computer-readable (for example, non-transitory) recording medium. In the following description, two or more programs may be implemented as one program, or one program may be implemented as two or more programs.

The computer system may be a distributed system including one or more (typically, a plurality of) physical node devices. The physical node device is a physical computer.

In the following description, an identification number is used as identification information of various targets, but identification information of a type other than the identification number (for example, an identifier including an alphabetic character or a code) may be adopted.

In addition, in the following description, reference signs (or a common code among the reference signs) may be used in a case where the same type of elements are described without distinguishing from each other, and identification numbers (or reference signs) of the elements may be used when the same type of elements are described with distinguishing from each other.

### First Embodiment

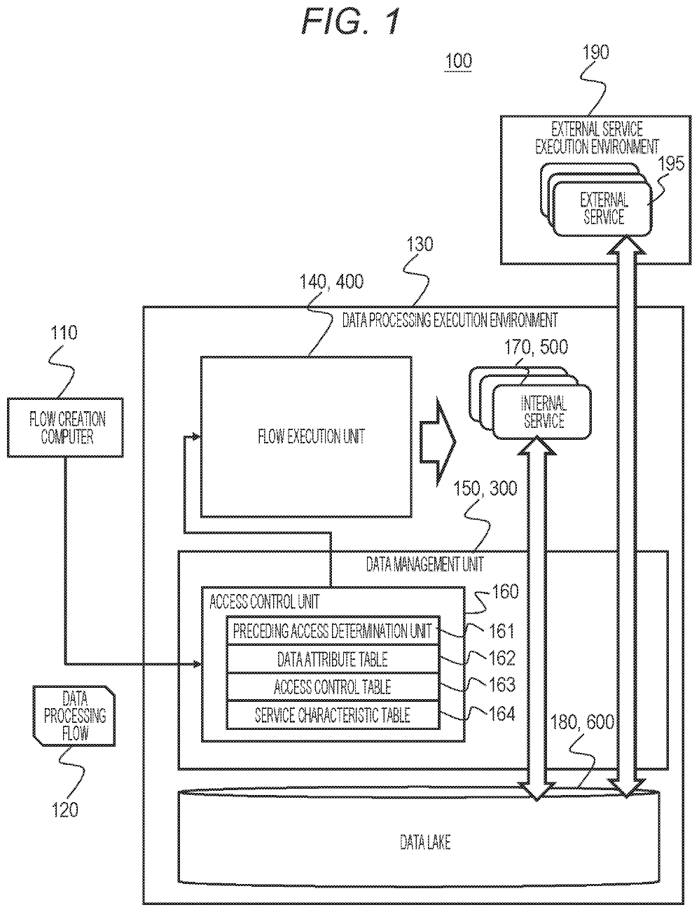

FIG. 1 is a configuration diagram illustrating a computer system 100 targeted by a first embodiment. The computer system 100 includes a data processing execution environment 130 that performs any working and analysis processing on data, and a flow creation computer 110 that creates a procedure (data processing flow) of data processing executed in the data processing execution environment 130.

A plurality of internal services 170 in the data processing execution environment 130 and an external service 195 in an external service execution environment 190 actually perform data working, and data processing proceeds as the services read and write data in a data lake 180. In a data processing flow 120, a correspondence relation between each of the services and data in the data lake is defined. A creator of a data processing flow creates a data processing flow 120 in the flow creation computer 110, and transmits the data processing flow 120 to the data processing execution environment 130 (specifically, a data management unit 150) to request data processing. In the following description, the data processing flow may be simply referred to as a flow.

A flow of data processing of the data processing execution environment 130 is as follows. When receiving the data processing flow 120, the data management unit 150 in the data processing execution environment 130 first causes an access control unit 160 in the data management unit 150 to detect an access violation. The access violation is detected by the access control unit 160 analyzing the description content of the data processing flow 120. The access control unit 160 detects the access violation by comparing a data attribute management table 162, an access control table 163, and a service characteristic table 164 based on the content of data between the internal service 170 provided in the data processing execution environment 130 or the external service 195, and the data lake 180 and based on the content of working applied to the data so far.

When the access control unit 160 detects the access violation in the data processing flow 120 from the analysis result, the subsequent processing is stopped. When the access violation is not detected, the data processing flow 120 is output to a flow execution unit 140. The flow execution unit 140 performs control among the internal service 170, the external service 195, and the data lake 180, based on the description of the data processing flow 120, and performs data processing. As described above, it is possible to detect the access violation of data before the flow execution unit 140 actually performs working and conversion processing of the data. In addition, it is possible to prevent waste of resources and the processing time due to execution of the data processing flow in which the access violation occurs.

Regarding an access to data in the data lake 180 by the internal service 170 and the external service 195, the access control unit 160 in the data management unit 150 determines the access violation one by one.

The flow creation computer 110 is a computer including a display unit used to create and edit the data processing flow 120.

Details of each component and processing illustrated in FIG. 1 will be described below.

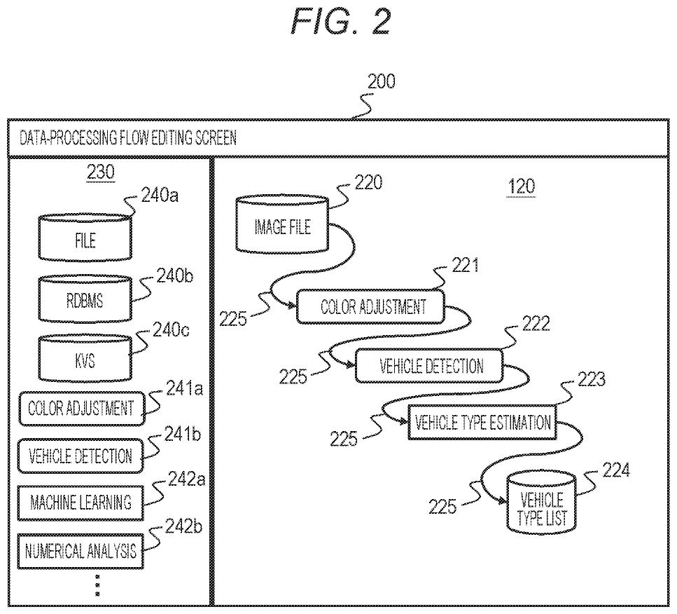

FIG. 2 illustrates an example of creating the data processing flow 120 by the flow creation computer 110. The flow creation computer 110 creates a data processing flow in which a data processing procedure is indicated by an arrangement of a plurality of nodes. Each node performs predetermined data processing.

A data-processing flow editing screen 200 shows a screen of the display unit that edits the data processing flow created by the flow creation computer 110 with a GUI. The content of data working is represented as a node on the data-processing flow editing screen 200, and an input/output of data is represented by an edge indicating the arrangement between the nodes. Each node executes processing (referred to as a “service” below) of performing predetermined working and conversion on data. In a node list 230, a list of available nodes is displayed. The available nodes indicate various “services”, and include a data node group 240 representing data in the data lake 180, an internal processing node group 241 representing the internal service 170, and an external processing node group 242 representing the external service 195.

The creator of the data processing flow creates the data processing flow by selecting and arranging the nodes and connecting the nodes with edges. That is, a data processing procedure can be defined as the data processing flow by the arrangement of nodes.

For example, in the data processing flow 120 in FIG. 2, an example in which image data shown in a monitoring camera is analyzed and vehicle types shown in the monitoring camera are listed. In the data processing flow 120, an image file node 220 corresponding to an image file stored in the data lake 180, a color adjustment node 221 corresponding to a color adjustment service for image data, a vehicle detection node 222 corresponding to a vehicle detection service for image data, a vehicle type estimation node 223 corresponding to a vehicle type estimation service for image data of a vehicle, and a vehicle type list node 224 that stores data on a vehicle type list in the data lake 180 are sequentially connected with edges 225. As described above, in the data processing flow, a data processing procedure is defined by the arrangement of the nodes that execute services being pieces of predetermined data processing.

The expression formats of the data processing flow 120 and the data-processing flow editing screen 200 are not limited to the formats in FIG. 2. For example, although FIG. 2 illustrates a flow and an editing screen of the flow by a GUI, the flow may be described by a text-based command or script, or may be described by using a GUI and text together.

The external service execution environment 190 is an environment for providing the external service 195 for performing data processing, and a specific internal configuration of the external service execution environment 190 is not limited. As a configuration example, a public cloud that provides artificial intelligence or machine learning as an external service is exemplified.

Details of the data management unit 150, the flow execution unit 140, the internal service 170, and the data lake 180 will be described below. The data management unit 150, the flow execution unit 140, the internal service 170, and the data lake 180 are provided as computers that perform respective roles in the data processing execution environment 130. The data management unit 150, the flow execution unit 140, the internal service 170, and the data lake 180 may be provided as individual computers, or a single computer may have a plurality of functions of the data management unit 150, the flow execution unit 140, the internal service 170, and the data lake 180. A single role may be configured by a plurality of computers.

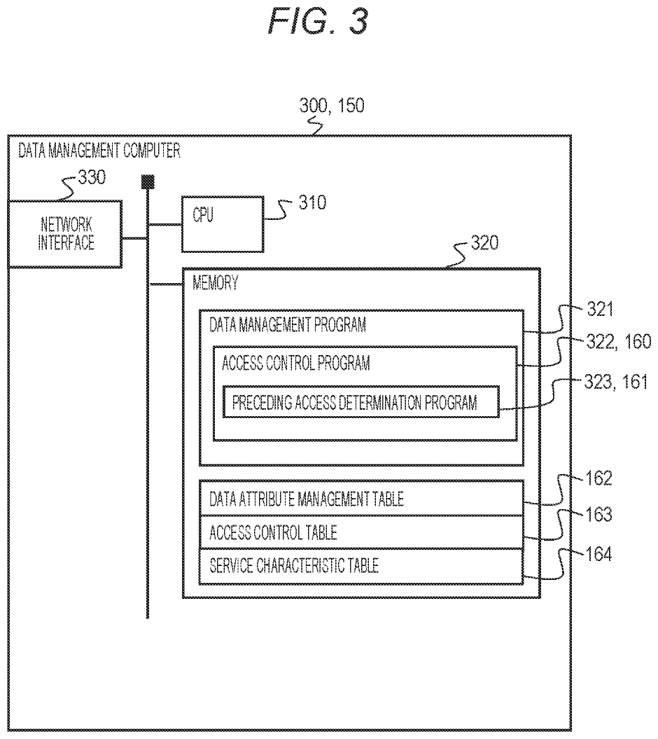

FIG. 3 illustrates a configuration of a data management computer 300 that serves as the data management unit 150. The data management computer 300 is connected to the flow creation computer 110, the data lake 180, and the flow execution unit 140, and detects an access violation of the data processing flow. The data management computer 300 includes a central processing unit (CPU) 310, a memory 320, and a network interface 330. The CPU 310 is a processing unit that controls each component of the data management computer 300 in accordance with descriptions of various programs stored in the memory 320.

The memory 320 includes a data management program 321, a data attribute management table 162, an access control table 163, and a service characteristic table 164. The data management program 321 is a program that manages list information of data saved by the data lake 180 and information on an amount of data and the like. As one function, the data management program 321 includes an access control program 322.

The access control program 322 is a program in which the operation of the access control unit 160 in the computer system 100 is actually described. The access control program 322 determines whether a data access to the data lake 180 by the internal service 170 and the external service 195 is permitted.

In addition, the access control program 322 includes a preceding access determination program 323. The preceding access determination program 323 is a program in which the operation of a preceding access determination unit 161 in the computer system 100 is actually described. The preceding access determination program 323 has a function of analyzing the data processing flow 120 and determining whether there is an access violation, from the description on the flow.

The memory 320 stores the data attribute management table 162, the access control table 163, and the service characteristic table 164, which are referred to by the preceding access determination program 323. The data attribute management table 162, the access control table 163, and the service characteristic table 164 may be stored in a place other than the memory 320 as long as the data attribute management table 162, the access control table 163, and the service characteristic table 164 can be referred to from the preceding access determination program 323. For example, the data attribute management table 162, the access control table 163, and the service characteristic table 164 may be stored in a storage device outside the computer, or may be acquired from another computer via the network interface 330.

The network interface 330 is an interface for transmitting and receiving data between the data management computer 300 and other computers (flow creation computer 110 and flow execution computer 400). For example, a network interface card (NIC) or a wireless network interface corresponds to the network interface 330.

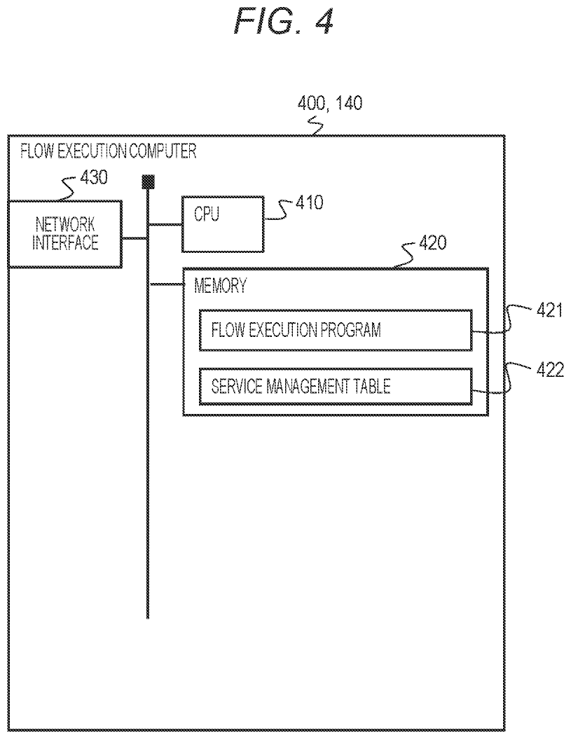

FIG. 4 illustrates a configuration of the flow execution computer 400 that serves as the flow execution unit 140 that executes the data processing flow. The flow execution computer 400 includes a CPU 410, a memory 420, and a network interface 430. The CPU 410 and the network interface 430 are similar to those in the data management computer 300. The CPU 410 is a processing unit that controls each component of the flow execution computer 400 in accordance with descriptions of various programs stored in the memory 420.

The memory 420 stores a flow execution program 421 and a service management table 422. The flow execution program 421 is a program that, when receiving the data processing flow 120, sequentially makes processing requests to the internal service 170 and the external service 195 in accordance with the description and proceeds data processing. The flow execution program 421 receives the data processing flow 120 from the data management computer 300 via the network interface 430, and requests the internal service 170 and the external service 195 for processing. The service management table 422 stores a list of the internal services 170 and the external services 195 that can be used in the data processing execution environment 130.

Reading and writing of data in the data lake 180 by the internal service 170 or the external service 195 corresponding to the node in accordance with an instruction of the flow execution program 421 is expressed as “a xx node processes data”, “executes a xx node”, “reads and writes data of a xx node”, and the like. For example, when the data processing flow 120 is received, the color adjustment node 221 adjusts the color of an image read from the image file node 220 in accordance with an instruction of the flow execution program 421. Then, when the adjustment result is output to the following vehicle detection node 222, the vehicle detection node 222 performs vehicle detection in the image. The detection result is output to the vehicle type estimation node 223, and the estimation result is stored in the vehicle type list node 224.

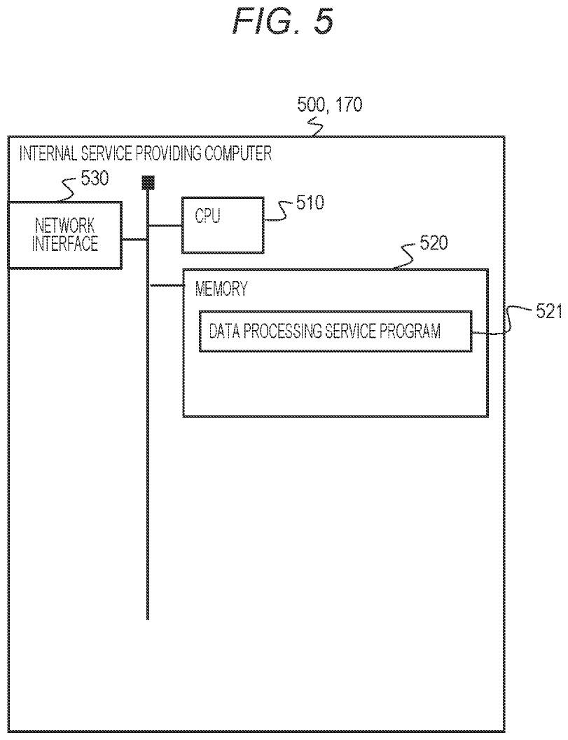

FIG. 5 illustrates a configuration of an internal service providing computer 500 that serves as the internal service 170. The internal service providing computer 500 includes a CPU 510, a memory 520, and a network interface 530. The CPU 510 and the network interface 530 are similar to those in the data management computer 300. The CPU 510 is a processing unit that controls each component of the internal service providing computer 500 in accordance with descriptions of various programs stored in the memory 520.

The memory 520 stores a data processing service program 521. The data processing service program 521 analyzes and performs working on data while reading and writing data saved in the data lake 180, in response to a processing request from the flow execution program 421.

In the data processing execution environment 130, a plurality of internal service providing computers 500 having different data processing service programs 521 may be provided. For example, as the data processing service program 521, statistical analysis of numerical data, image recognition, natural language analysis, acoustic analysis, voice synthesis, and a question response system can be considered. In addition, the internal service providing computer 500 may hold additional hardware and software such as a graphic processing unit (GPU), a dedicated field programmable gate array (FPGA), and an application specific integrated circuit (ASIC) so as to speed up the processing of the data processing service program 521 and handle large-amount data. In addition, the internal service providing computer 500 may have a configuration in which a single internal service 170 is provided by combining calculation resources of a plurality of internal service providing computers 500.

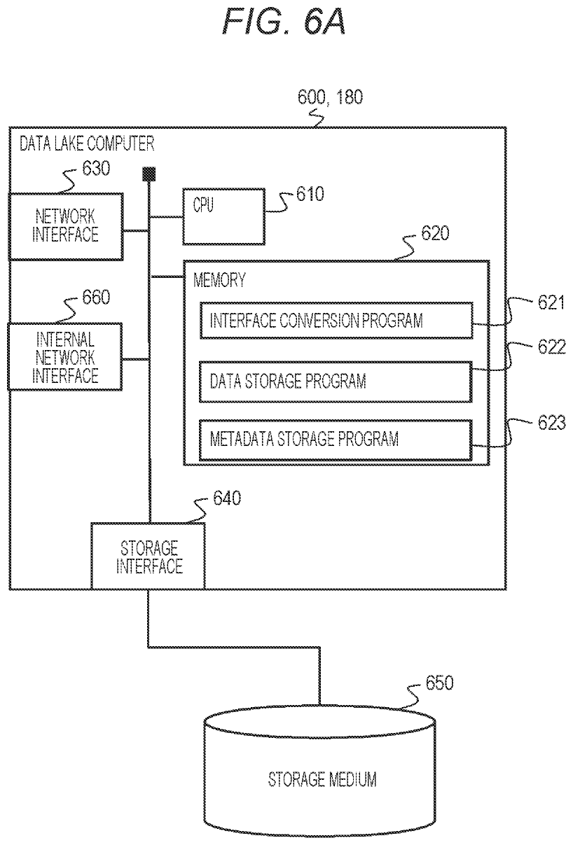

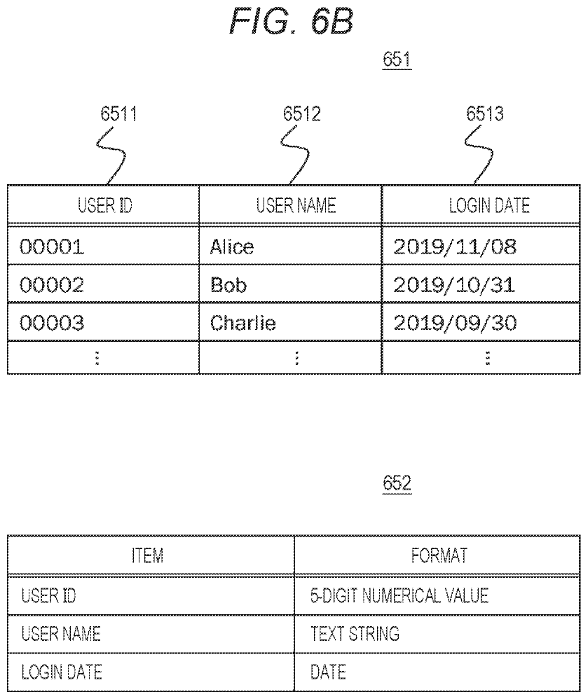

FIG. 6A illustrates a configuration of a data lake computer 600 that serves as the data lake 180. The data lake 180 stores various types of data for reading and writing of the internal service 170 and the external service 195. In general, the data lake 180 is characterized in that various types of data can be read and written by various interfaces and a large amount of data can be saved. As the data type, structured data, unstructured data, text, an image, an audio, binary, and the like can be targeted. As the interface, a file, an object, a block, a relational database management system (RDBMS), a key value store (KVS), and the like can be considered. In general, when an identifier (text string, numerical value, hash number, and the like) related to data or a condition of data is designated, it corresponds to a device that can input and output corresponding data.

FIG. 6B illustrates an example of the RDBMS as information regarding a structure and an attribute of data stored in the data lake.

The RDBMS handles a series of pieces of data in units of tables and manages data by using a plurality of tables. A table 651 saves data in a two-dimensional table format in which pieces of information of a user ID 6511, a user name 6512, and a login date 6513 are managed by columns.

A schema 652 indicating what meaning each column of the table 651 has and what format data is saved is set in the table. The schema indicates a 5-digit numerical value, a text string, and a date with an item as information indicating a data structure.

Returning to FIG. 6A, the data lake computer 600 includes a CPU 610, a memory 620, a network interface 630, an internal network interface 660, and a storage interface 640. The data lake computer 600 is connected to a storage medium 650 via the storage interface 640. The CPU 610 and the network interface 630 are similar to those in the data management computer 300. The CPU 610 is a processing unit that controls each component of the data lake computer 600 in accordance with descriptions of various programs stored in the memory 620.

The memory 620 stores an interface conversion program 621, a data storage program 622, and a metadata storage program 623. The interface conversion program 621 is a program that interprets various protocols and interfaces in the data access request of the internal service 170 and the external service 195 and realizes a data input/output. Examples of the corresponding interface include a network file system (NFS), a server message block (SMB), and a file transfer protocol (FTP) as a file interface, an S3 protocol and a Swift protocol as an object storage interface, SCSI, SAS, and an Internet SCSI (iSCSI) as a block storage interface, open database connectivity (ODBC) used for database connection and a structured query language (SQL) used for inquiry as an interface for an RDBMS.

The data storage program 622 stores arrangement information of data saved by the data lake 180 on the storage medium 650. For example, there is a file system as an example of the data storage program 622.

The metadata storage program 623 stores supplementary information of data saved by the data lake 180 on the storage medium 650. For example, an extended attribute of a file to be stored on the data lake 180, a schema of a database, or the like corresponds to the metadata storage program 623.

The data lake computer 600 is connected to the storage medium 650 via the storage interface 640. The storage medium 650 is a medium that stores data for a long period of time, and corresponds to a magnetic storage medium (hard disk drive (HDD) or magnetic tape), a flash memory (solid state drive (SSD) or universal serial bus (USB) flash drive), an optical disk (compact disc (CD), digital versatile disc (DVD), or Blu-ray (registered trademark) disc (BD)), or a bundle of the media by a technique such as a redundant array of independent disks (RAID) or an erasure coding (EC). As a communication path between the storage interface 640 and the storage medium 650, the above-described SCSI, SAS, serial ATA (SATA), NVM express (NVMe), and the like can be considered.

The data lake computer 600 may be constructed by bundling a plurality of computers in order to realize a large-capacity and high-performance data storage. In this case, the internal network interface 660 is used to transmit and receive data between the plurality of computers.

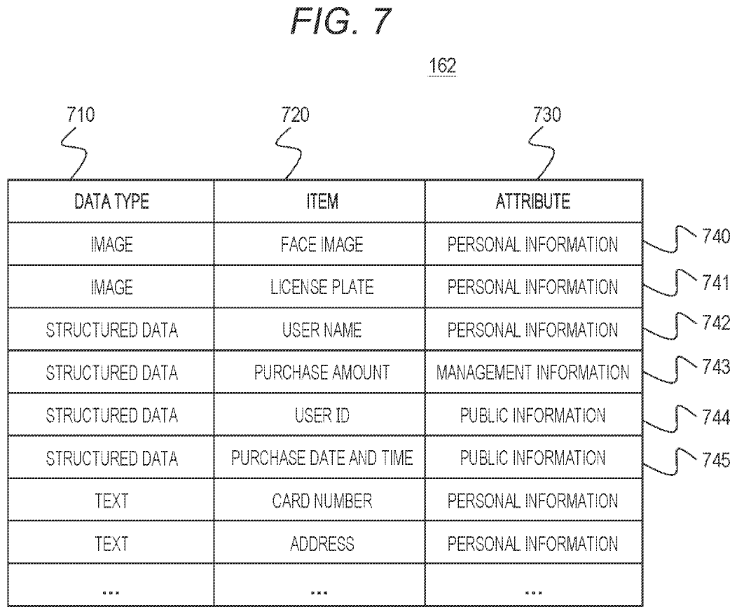

FIG. 7 illustrates a configuration example of the data attribute management table 162. The data attribute management table 162 indicates what kind of information can be saved for data appearing in the data lake 180 and the data processing flow 120. The column includes a data type 710, an item 720, and an attribute 730.

The data type 710 indicates a data type indicating an output format of target data. The item 720 indicates the name of a data item indicating the type of information included in the data type. The attribute 730 indicates information regarding data confidentiality as an attribute of data.

For example, an entry 740 indicates data in which the data type is an image, the item 720 is a face image, and the attribute 730 is an attribute of personal information.

An entry 741 indicates that a license plate image of a vehicle corresponding to the personal information can be stored in image data.

An entry 742 indicates that the user name corresponding to the personal information can be stored in structured data.

An entry 743 indicates that the purchase amount corresponding to management information can be stored in structured data.

An entry 744 indicates that the user ID corresponding to public information can be stored in structured data.

An entry 745 indicates that the purchase date and time corresponding to public information can be stored in structured data.

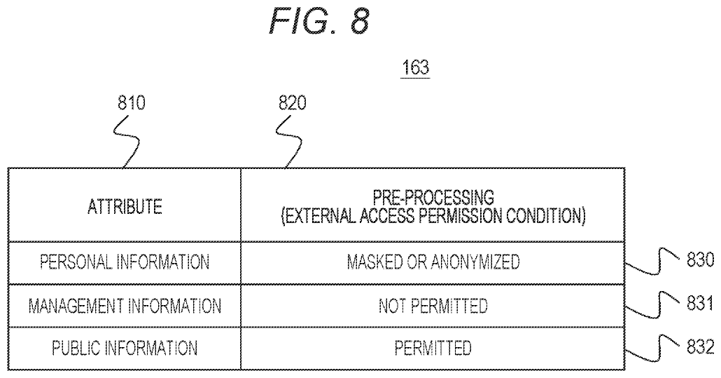

FIG. 8 illustrates an example of the access control table 163. The access control table 163 indicates what kind of data can be referred to from the external service 195 if what kind of processing is performed as pre-processing. The access control table 163 includes an attribute 810 representing an attribute of data and an external access permission condition 820 representing the content of pre-processing. The attribute 810 is information regarding the confidentiality of information corresponding to the entry, and includes the content corresponding to the attribute 730 in the data attribute management table 162.

The external access permission condition 820 indicates the content of the pre-processing, that is, what pre-processing may be performed on data in advance when the data corresponding to the attribute 810 is referred to from the external service 195.

For example, in an entry 830, data corresponding to personal information as an attribute indicates that an access is permitted if masking or anonymization processing is performed in advance as pre-processing.

In an entry 831, data corresponding to management information indicates that an access is not permitted even if any pre-processing is performed.

In an entry 832, data corresponding to public information indicates that an access is normally permitted without limitation regarding pre-processing.

The contents of the data attribute management table 162 and the access control table 163 are not necessarily provided in the data management unit 150, and some or all of the contents may be saved by another part. In addition, information corresponding to the data attribute management table 162 and the access control table 163 may be generated by converting information included in another part in accordance with some rules.

For example, since the data lake 180 may have management information of an access right to data, such as an access control list (ACL) in file sharing and a role in an RDBMS, the management information can be used. For example, items such as a user ID can be used.

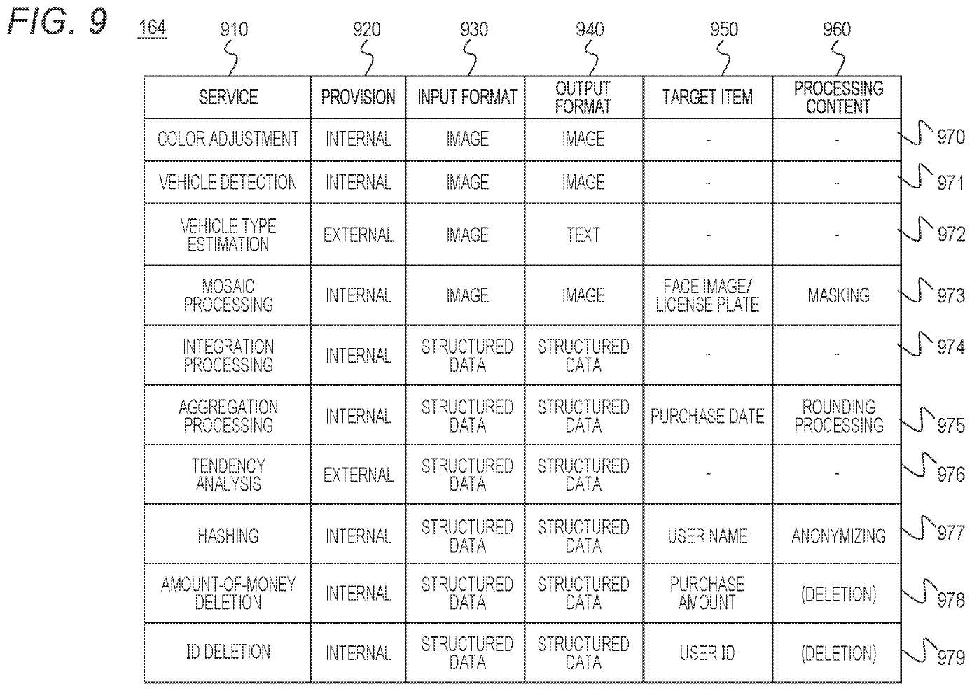

FIG. 9 illustrates an example of the service characteristic table 164. The service characteristic table 164 is information for managing characteristics of a “service”, such as a place where processing is executed, an input/output format of data, a processing target, and a processing content. A service 910 is data processing executed in each node in FIG. 2. The service 910 is managed in association with a provision 920 being information indicating whether processing is executed by the internal service 170 or the external service 195, as a place where processing is executed, an input format 930 of data as an input/output format of data, an output format 940 of data, a target item 950 as a processing target, and a processing content 960 indicating a content of data processing executed in each service.

More specifically, the service 910 corresponds to data processing of the node of the data processing flow illustrated in FIG. 2. The provision 920 indicates whether the service to which each entry corresponds is an internal service or an external service. The input format 930 and the output format 940 indicate formats of data input and output by the service corresponding to each entry. The target item 950 indicates whether the service indicated by the service 910 performs pre-processing on the processing target (item). The target item 950 includes content corresponding to the item 720 in the data attribute management table 162. The processing content 960 indicates pre-processing of the item indicated by the target item 950 to be executed for each service 910. The target item 950 and the processing content 960 may be left blank when the processing is not performed.

For example, an entry 970 indicates that the color adjustment service being the internal service inputs and outputs image data, and does not perform pre-processing on confidential data.

An entry 971 indicates that the vehicle detection service being the internal service inputs and outputs image data, and does not perform pre-processing on confidential data.

An entry 972 indicates that the vehicle type estimation service being the external service receives image data as input, does not perform pre-processing on confidential data, and outputs text data.

An entry 973 indicates that a mosaic processing service being the internal service inputs and outputs image data, and performs masking processing on a face image and a license plate.

Information indicating whether the place where the service is executed is inside or outside the country or inside or outside the company may be added to the provision 920, in addition to the types of the internal service and the external service.

Entries 974 to 978 will be described in a second embodiment because of being used in the second embodiment described later.

The data management unit 150 does not necessarily include the service characteristic table 164. For example, each internal service 170 or external service 195 may have information corresponding to the input format 930, the output format 940, the target item 950, and the processing content 960 as the content of pre-processing performed by each service and the target data format. In this case, the preceding access determination unit 161 can construct information equivalent to the service characteristic table 164 by collecting information saved by each service.

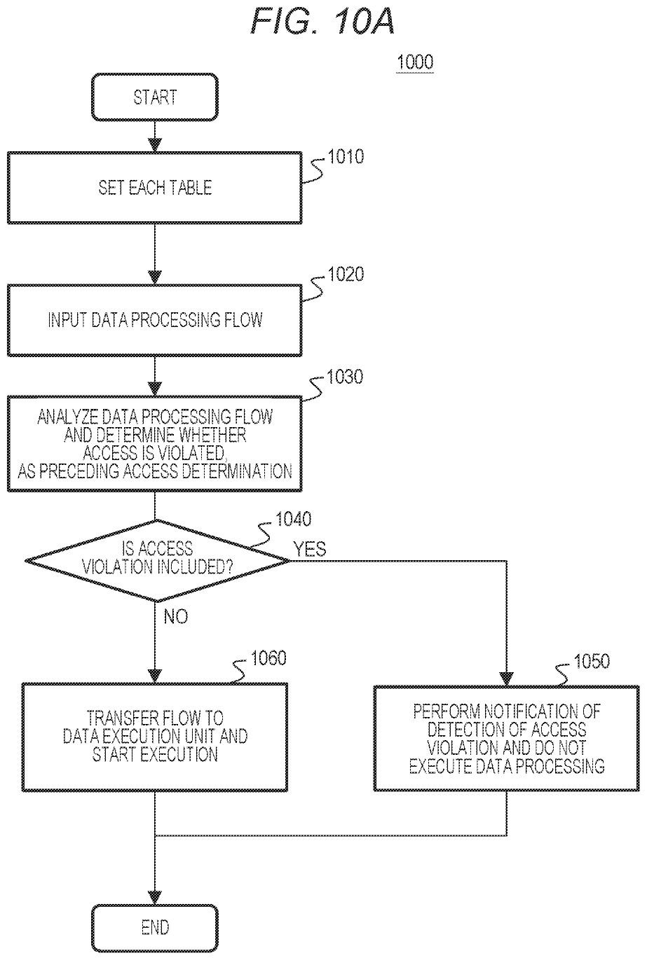

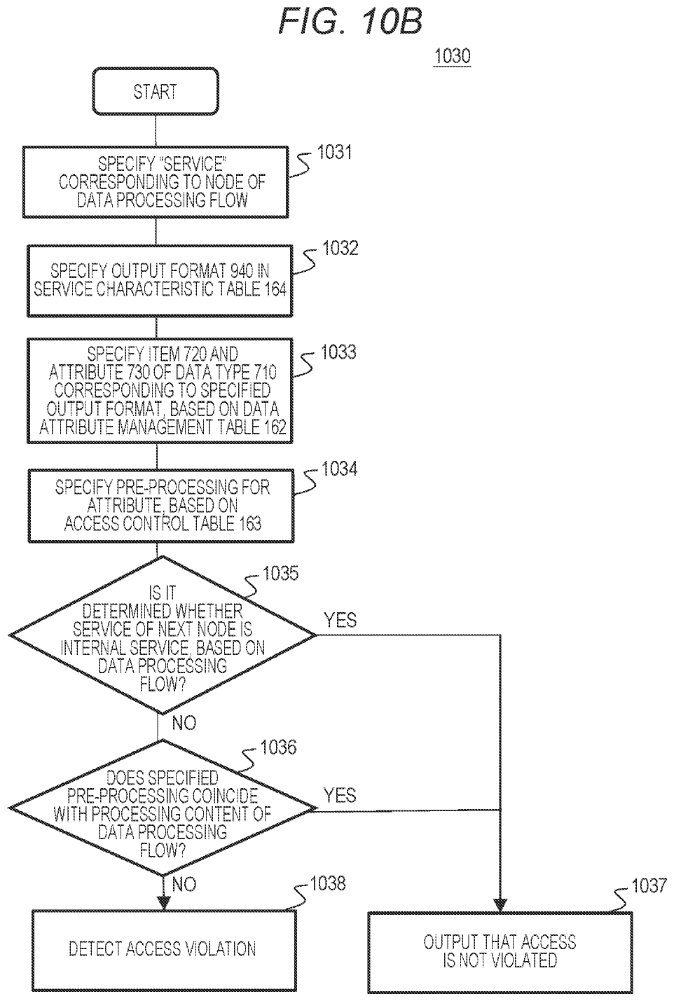

FIG. 10A illustrates a data-processing-flow execution flow 1000 in which the CPU 310 being the processing unit of the data management computer 300 executes the access control program 322. Step 1010 is performed only once before individual data processing is performed. In Step 1010, the data attribute management table 162, the access control table 163, and the service characteristic table 164 are created. It can be considered that this work is performed by, for example, a storage administrator who manages the data lake 180 or a security person of the data processing execution environment 130.

In Step 1020, the data processing flow 120 is input from the flow creation computer 110 to the data management computer 300. The data processing flow 120 is created by using the data-processing flow editing screen 200 operated by the flow creation computer 110. This work is performed by a data processing designer such as a data scientist, for example.

In Step 1030, upon receiving the data processing flow 120, the access control unit 160 in the data management computer 300 performs preceding access determination.

The detailed operation of Step 1030 will be described with reference to FIG. 10B. This process is performed in a manner that the CPU 310 being the processing unit of the data management computer 300 executes the access control program 322.

In Step 1031, when receiving the data processing flow 120 from the flow creation computer 110, the data management computer 300 specifies a “service” corresponding to the node. For example, the data management computer 300 specifies a service called color adjustment, from the color adjustment node 221 of the data processing flow 120.

In Step 1032, the data management computer 300 specifies the output format 940 of the service specified in Step 1031, based on the service characteristic table 164. For example, the data management computer 300 specifies that the output format of the service called color adjustment is “image”.

In Step 1033, the data management computer 300 recognizes the item 720 and the attribute 730 of the data type 710 corresponding to the specified output format 940, based on the data attribute management table 162. For example, when the specified output format is an image, the data management computer 300 recognizes “face image” as the item 720, and recognizes “personal information” as the attribute 730. In this step, the data management computer 300 may specify only the attribute 730.

In Step 1034, the data management computer 300 specifies the pre-processing 820 for the attribute 810 in which the same content as that of the attribute 730 is stored, based on the access control table 163. For example, the data management computer 300 specifies the pre-processing 820 “masked or anonymized” for the personal information of the attribute 810.

In Step 1035, the data management computer 300 determines whether the service of the next node in the data processing flow 120 is the internal service 170, based on the service characteristic table 164. For example, if the next node in the data processing flow is “vehicle detection”, the service of the next node is determined to be the internal service. If the next node is “vehicle type estimation”, the service of the next node is determined to be the external service.

When information indicating whether the service execution place is inside or outside the country or information indicating whether the service execution place is inside or outside the company is stored in the provision 920 of the service characteristic table 164, a step of determining whether the service of the next node is inside the country or inside the company may be provided. This is because access violation generally becomes a problem when data is provided outside the company or outside the company.

When it is determined in Step 1035 that the service of the next node is the internal service, the process proceeds to Step 1037. When it is determined that the service of the next node is the external service, the process proceeds to Step 1036.

In Step 1036, the data management computer 300 determines whether the pre-processing specified in Step 1034 coincides with the processing content of the received data processing flow 120. When the specified pre-processing coincides with the processing content of the data processing flow 120, the process proceeds to Step 1037. When the specified pre-processing does not coincide with the processing content of the data processing flow 120, the process proceeds to Step 1038. The processing content of the data processing flow 120 can be recognized from the processing content 960 of the service characteristic table 164 from the specified “service”.

The access violation between the nodes in the data processing flow 120 is detected in a manner as follows. That is, pre-processing required when a service indicated by each node in the data processing flow 120 transfers (outputs) data to a service of the next node is specified from the data attribute management table 162 and the access control table 163. The processing content of each node in the data processing flow 120 is specified from the service characteristic table 164. Then, it is determined whether the pre-processing and the processing content satisfy conditions (for example, coincide with each other).

When it is determined in Step 1035 that the service of the next node is the internal service, or when the pre-processing specified in Step 1036 coincides with the processing content of the data processing flow, the data management computer 300 outputs a message indicating that there is no access violation, in Step 1037.

When the specified pre-processing does not coincide with the processing content of the data processing flow in Step 1036, the data management computer 300 detects the access violation in Step 1038.

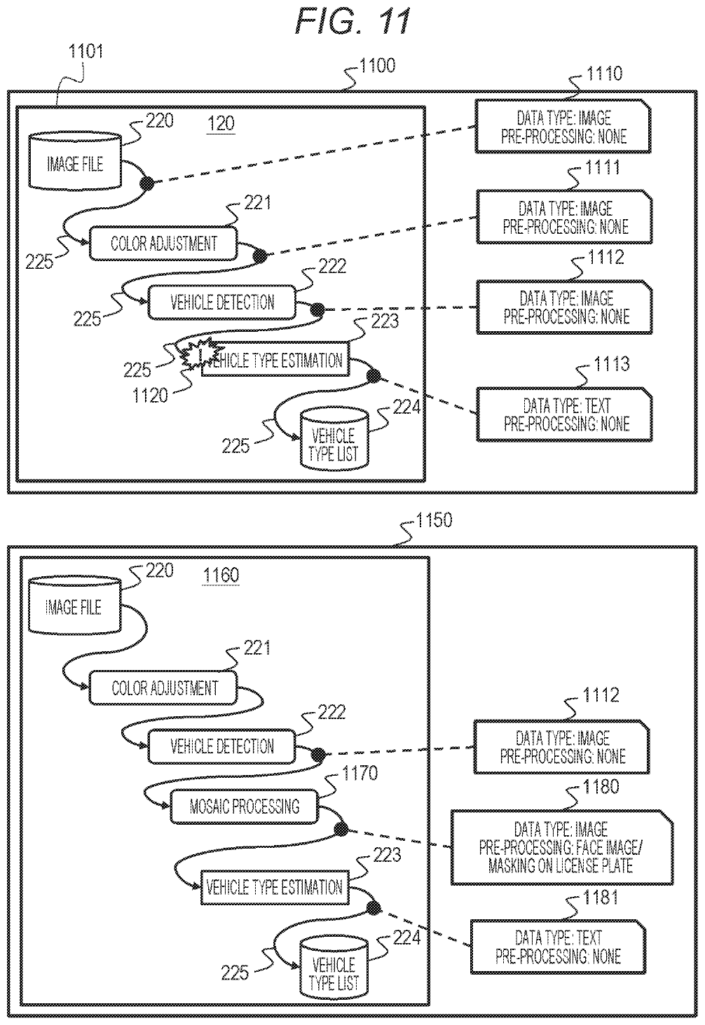

A detection example of the access violation will be described with reference to FIG. 11. An example of an analysis result of the data processing flow 120 described above by the access control unit 160 will be described. The data management computer 300 transmits the analysis result of the data processing flow to the flow creation computer 110. The display unit of the flow creation computer 110 displays the analysis result of the data processing flow. An analysis result 1100 of the data processing flow includes a flow analysis result 1101 and calculation results 1110, 1111, 1112, and 1113.

For an edge 225 in the data processing flow 120, a data type flowing through the edge and pre-processing to be performed are calculated based on the contents of the service characteristic table 164. The calculation results 1110, 1111, 1112, and 1113 of the access control unit 160 indicate the calculation results before execution of the color adjustment node 221, before execution of the vehicle detection node 222, before execution of the vehicle type estimation node 223, and after execution of the vehicle type estimation node 223, respectively. The calculation result refers to contents specifying the output format 920 specified in Step 1032 by the access control unit 160, the data type 710 corresponding to the output format 920, the attribute 730 corresponding to the data type 710, and the pre-processing 820 corresponding to the attribute 730 (attribute 810).

According to the service characteristic table 164 in FIG. 9, the color adjustment node 221 and the vehicle detection node 222 correspond to internal services, and the vehicle type estimation node 223 corresponds to an external service.

Here, the calculation result 1112 means that image data flows to the vehicle type estimation node 223 being the external service without performing any pre-processing. The entries 740 and 741 of the data attribute management table 162 indicate that the image data includes a face image and a license plate corresponding to personal information. Referring the personal information from an external service, the entry 830 of the access control table 163 requests that masking or anonymization processing is performed as pre-processing. Thus, in such data processing, the image data including, as personal information, the face image or the license plate which are not masked or anonymized flows to the external service. Therefore, an occurrence of an access violation 1120 is detected in an output from the vehicle detection node 222 to the vehicle type estimation node 223, and it is determined that execution of the data processing flow 120 causes the access violation.

When the access violation 1120 is detected, the data management computer 300 transmits data indicating a place where the access violation occurs, to the flow creation computer 110 as an analysis result of the data processing flow. The flow creation computer 110 displays the data as the place where the access violation 1120 occurs, on the display unit.

When determining that the access violation occurs, the CPU 310 of the data management computer 300 specifies the pre-processing (service) specified as the processing to be executed, by the access control table 163 from the service characteristic table 164. Then, the CPU 310 transmits the specified pre-processing to the flow creation computer 110.

As a result, a user who creates the data processing flow with the flow creation computer 110 can insert a node that executes the service specified so that the access violation does not occur, into the place where the access violation has occurred.

When the violation is included as a result of the determination of the access violation in Step 1030 in the data-processing-flow execution flow 1000, the process branches in Step 1040. Then, the detection of the access violation in Step 1050 is transmitted from the data management computer 300 to the flow creation computer 110 so as to notify a flow creator. When the access violation is detected, the data-processing-flow execution flow 1000 is ended without transmitting the data processing flow to the flow execution computer 400.

At this time, not only the flow creator is simply notified of the access violation, but also a method of resolving the violation can be suggested. For example, the entry 830 of the access control table 163 indicates that the personal information is permitted to flow to the external service 195 if masking or anonymization processing has been performed as the pre-processing. Thus, the processing unit 310 in the data management computer 300 performs control so as to search the service characteristic table 164 for a service of masking the face image and the license plate corresponding to the personal information in the image data, specify a mosaic processing service from the entry 973, and transmit the mosaic processing service to the flow creation computer 110. At this time, insertion immediately before the access violation 1120 can be suggested as a position at which the mosaic processing service is performed in the flow.

When it is determined that the violation is not included as the result of the determination of the access violation in Step 1030, the process branches in Step 1040 and proceeds to Step 1060. In Step 1060, the access control unit 160 in the data management computer 300 transmits the data processing flow 120 to the flow execution unit 140 (flow execution computer 400), requests flow execution by the flow execution unit 140, and then ends the data-processing-flow execution flow 1000.

Next, an example of avoiding the access violation by adding appropriate pre-processing will be described. A data processing flow 1160 in FIG. 11 is obtained by modifying the data processing flow 120, and inserting a mosaic processing node 1170 between the vehicle detection node 222 and the vehicle type estimation node 223. An analysis result 1150 of the data processing flow indicates an example of an analysis result of the data processing flow 1160.

The processing unit 310 in the data management computer 300 specifies a node to be added so that appropriate pre-processing is performed on the output of the node of the data processing flow, in which it is determined that the access violation occurs. The node to be added refers to a service that performs pre-processing on the data attribute specified by the access control table 163 in Step 1034 in FIG. 10B. This service is specified from the service characteristic table 164.

Results up to the calculation result 1112 after the vehicle detection service 222 is performed are similar to the analysis result 1100 of the data processing flow. However, the mosaic processing node 1170 is inserted in the data processing flow 1160, and information indicating that masking as the pre-processing has been performed on the face image or the license plate in accordance with the description of the entry 973 of the service characteristic table 164 is added to the calculation result 1180 after the service is performed.

Data corresponding to the calculation result 1180 flows to the vehicle type estimation service 223 corresponding to an external processing node. It can be seen from the entry 740 and the entry 741 of the data attribute management table 162 that the image data includes the face image and the license plate as the personal information, but the face image and the license plate are masked as indicated by the calculation result 1180. According to the entry 830 of the access control table 163, since the masked personal information can be externally accessed, it is determined that the flow of the data to the vehicle type estimation service 223 is not the access violation. Therefore, the data processing flow 1160 then proceeds to Step 1060 in the data-processing-flow execution flow 1000, and is executed by the flow execution unit 140.

According to the first embodiment, the data processing execution environment that has received the data processing flow can detect the access violation and perform a notification, by the data management computer before the flow execution unit performs working and conversion of data. In addition, it is possible to prevent waste of time, computer resources, and energy due to data working and conversion being in progress. In addition, it is possible to determine the access violation for the confidential information in advance before the service or the processing is executed, and thus to efficiently create a data processing flow in which the access violation does not occur.

In addition, when the violation is detected, by suggesting a countermeasure of what pre-processing has been performed to avoid the violation, the time taken to crate the flow in which the violation has been resolved is also shortened.

### Second Embodiment

Depending on the type of data provided by the data lake 180, the data is structured and contains information regarding the structure and attributes of the data. For example, an RDBMS, a JavaScript (registered trademark) object notation (JSON) format, and the extensible markup language (XML) are such structured data. As the information regarding the structure and attributes of the data, there are columns and schemas in the RDBMS, JSON schemas in JSON, XML schemas in XML, and the like. Even though the data itself does not have information regarding the structure, information regarding the structure may be separately added. This includes extended attributes in a file, annotations for an image or a sentence, and the like.

When the flow processing execution flow 1000 proceeds, the attribute information of the structured data can be used for an item indicated by the item 720 in the data attribute management table 162 and the target item 950 in the service characteristic table 164.

In the case of the RDBMS illustrated in FIG. 6B, the user ID 6511, the user name 6512, and the login date 6513 are used as the items indicated by the item 720 of the data attribute management table 162 and the target item 950 in the service characteristic table 164.

The entries 974 to 978 used in the second embodiment in the service characteristic table 164 of FIG. 9 will be described.

The entry 974 indicates that an integration processing service being the internal service inputs and outputs structured data, and does not perform pre-processing on confidential data.

The entry 975 indicates that an aggregation processing service being the internal service inputs and outputs structured data, and lowers the accuracy by rounding a value of the purchase date in confidential data.

The entry 976 indicates that a tendency analysis service being the external service inputs and outputs structured data.

The entry 977 indicates that a hashing service being the internal service inputs and outputs structured data, and anonymizes the user name in confidential data.

The entry 978 indicates that an amount-of-money deletion service being the internal service inputs and outputs structured data, and deletes the purchase amount in confidential data.

The entry 979 indicates that an ID deletion service being the internal service inputs and outputs structured data, and deletes the user ID in the confidential data.

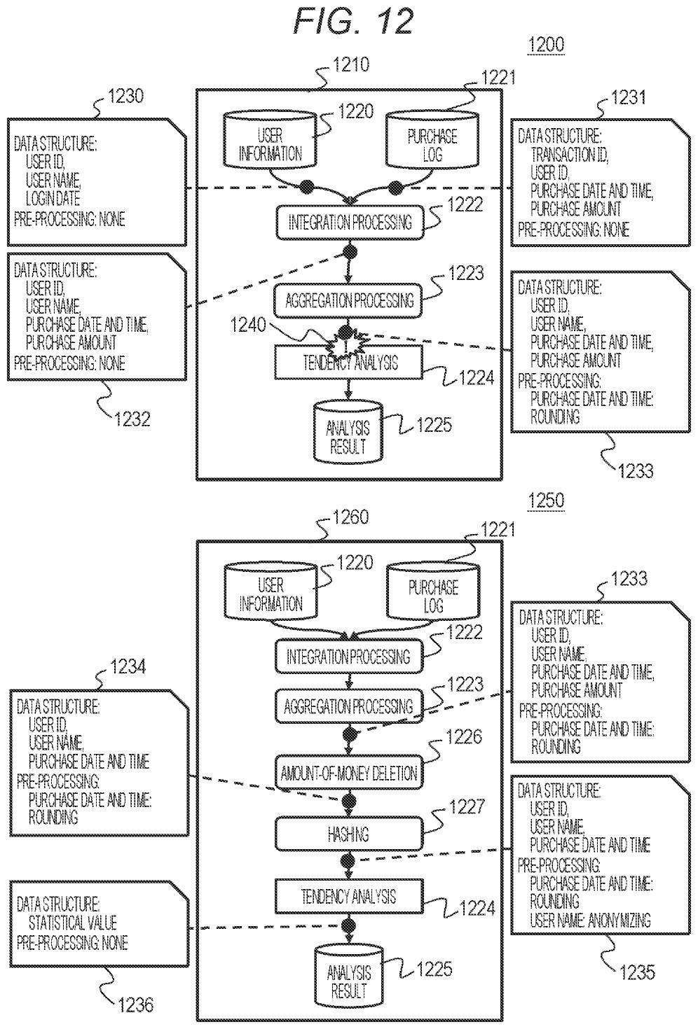

FIG. 12 illustrates an example of access right determination using attribute information of structured data in Step 1030 (see FIG. 10A) in the flow processing execution flow 1000. A data-processing-flow analysis result 1200 is obtained by calculating the data type flowing in the edge of the flow and the pre-processing to be performed in the processing flow 1210 targeting structured data.

A processing flow 1210 illustrates an example of assuming data of a product purchasing site and analyzing user information and purchase information in the data lake 180. In the processing flow 1210, data in a user information node 1220 corresponding to user information data in the data lake 180 and data in a purchase log node 1221 corresponding to purchase log data in the data lake 180 are integrated into single data by an integration processing node 1222 corresponding to the internal integration processing service. Then, the integrated data is aggregated by an aggregation processing node 1223 corresponding to an internal aggregation processing service.

The aggregated data is transmitted to a tendency analysis node 1224 corresponding to an external tendency analysis service, and the analysis result is stored in the data lake 180 corresponding to an analysis result node 1225. Calculation results 1230, 1231, 1232, and 1233 indicate the structure of data flowing in the flow and the execution status of pre-processing.

The operation will be described below assuming a table structure of the RDBMS. For example, it is assumed that, in the calculation result 1230, data flowing from the user information node 1220 to the integration processing node 1222 in the data processing flow 1210 is obtained by arranging a plurality of sets of data including a user ID, a user name, and a login date. It is assumed that, in the calculation result 1231, data flowing from the purchase log node 1221 to the integration processing node 1222 is obtained by arranging a plurality of sets of data including a transaction ID, a user ID, purchase date and time, and a purchase amount.

It is assumed that the integration processing node 1222 integrates pieces of data received from the user information node 1220 and the purchase log node 1221, the data structure indicated in the calculation result 1232 is transmitted to the aggregation processing node 1223, and the aggregation processing node 1223 performs aggregation for the purchase date and time. It is assumed that the structure of the data that has been processed up to the aggregation processing node 1223 is as the calculation result 1233.

According to the data attribute management table 162, in the calculation result 1233, the user name is personal information as indicated by the entry 742, and the purchase amount is management information according to the entry 743. When the personal information is not masked or anonymized according to the entry 830 of the access control table 163, the access from the external service is not permitted, and the management information is not normally permitted to be accessed from the external service. Therefore, the processing unit 310 in the data management computer 300 determines that the processing flow 1210 causes an access violation 1240 in the flow immediately before the execution of the tendency analysis node 1224.

An example of resolving the access violation 1240 by performing appropriate pre-processing is indicated in a data-processing-flow analysis result 1250. In a processing flow 1260, an amount-of-money deletion node 1226 corresponding to the internal amount-of-money deletion service and a hashing node 1227 corresponding to the internal hashing service are inserted between the aggregation processing node 1223 and the tendency analysis node 1224 in processing flow 1210.

The processing unit 310 in the data management computer 300 specifies a node to be added so that appropriate pre-processing is performed on the output of the node of the data processing flow, in which it is determined that the access violation occurs. The node to be added refers to a node that performs pre-processing on the data attribute specified by the access control table 163 in Step 1034 in FIG. 10B.

With the insertion of the nodes, the data structure flowing through the flow has changed, and the results are as shown in calculation results 1234, 1235, and 1236. The data structure processed by the aggregation processing node 1223 is the calculation result 1233 itself as described above. Here, when the processing by the amount-of-money deletion node 1226 is performed, the purchase amount is deleted in accordance with the entry 978 of the service characteristic table 164, and the data structure indicated in the calculation result 1234 is obtained.

Subsequently, when processing by the hashing node 1227 is performed, anonymization is performed as pre-processing on the user name in accordance with the entry 977 of the service characteristic table 164, and the data structure indicated in the calculation result 1235 is obtained. The calculation result 1235 does not include an item regarded as confidential information, and the user name regarded as personal information is anonymized as the pre-processing, it is determined that there is no violation of the conditions of the access control table 163 and there is no access violation.

According to the second embodiment, in addition to the effects of the first embodiment, it is possible to determine the access right by using the information regarding the data structure and attributes such as the user ID, the user name, and the login date included in the data lake 180.

### Third Embodiment

In the second embodiment, the change in the flow of the data structure and whether the pre-processing is applied are used only for the determination of the access violation, but the pieces of information can also be used for optimization of processing. For example, if the tendency analysis service 1224 does not use the user ID for analysis in the processing flow 1260, continuing to save the user ID in a series of processes wastes the processing time and the computer resources. In that case, it is desirable to delete the user ID early.

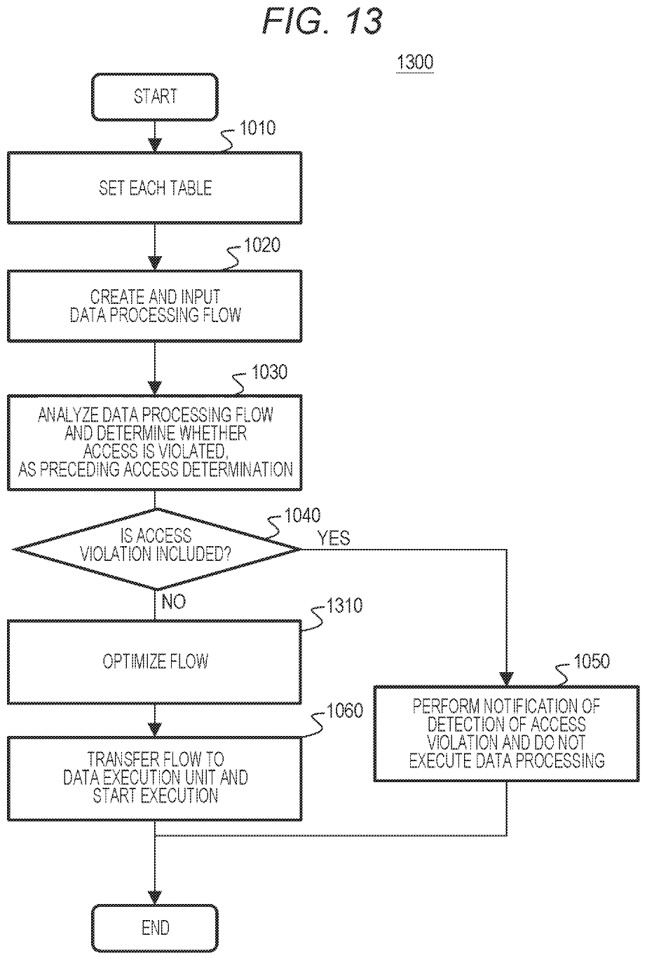

FIG. 13 illustrates an optimization-flow processing execution flow 1300. In the optimization-flow processing execution flow 1300, Step 1310 is inserted into the flow processing execution flow 1000 between the determination of the access violation in Step 1030 and the flow execution in Step 1060. In Step 1310, the flow is optimized by using the calculation result regarding the data structure in Step 1030. The optimized flow itself may be presented as an optimization plan to the creator of the flow and executed under the permission of the creator of the flow, or may be executed without indicating the optimized flow to the creator of the flow as there is no influence on the processing result.

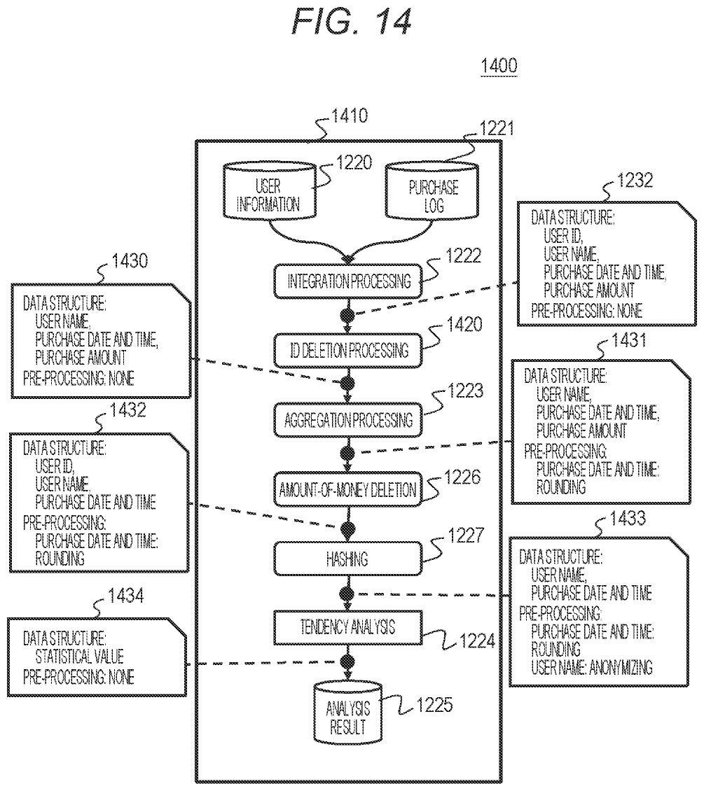

FIG. 14 illustrates an example of optimization of processing by using attribute information of structured data in Step 1030 of the flow processing execution flow 1000. As a premise, it is assumed that the data management unit 150 knows in advance that the tendency analysis service does not use the user ID. For example, this can be realized by adding details of data used by each service in a section of the input format 930 of the service characteristic table 164. Alternatively, the processing unit 310 in the data management computer 300 may perform control so as to specify a service (node to be executed) of deleting a data item that is not used among data items included in the data lake and transmit the service to the flow creation computer.

A data-processing-flow analysis result 1400 is obtained by calculating the data type flowing in the edge of the flow and the pre-processing to be performed in a processing flow 1410 for the structured data. In the processing flow 1410, an ID deletion node 1420 corresponding to an internal ID deletion service is inserted between the integration processing node 1222 and the tendency analysis node 1224 in the processing flow 1260. Data before execution of the ID deletion node includes the user ID as a data structure as indicated by the calculation result 1232. However, as indicated by the entry 979 of the service characteristic table 164, calculation results 1430, 1431, 1432, 1433, and 1434 in which the user ID is deleted by the ID deletion node 1420 indicate the data structure after the execution of the processing by the nodes 1420, 1223, 1226, 1227, and 1224 and the execution status of the pre-processing. The calculation results 1430, 1431, 1432, and 1433 are equal to the calculation results 1232, 1233, 1234, and 1235 except for the user ID.

According to the third embodiment, when a data processing flow of working and converting data on the data lake 180 is executed, it is possible to expect that the processing time and computer resources in execution of the data processing flow are reduced by optimizing the data processing flow so as to early delete unnecessary data by using information regarding the data structure and the attributes included in the data.

### Fourth Embodiment

In the first and second embodiments, the access right determination in Step 1030 is executed only when the creator of the data processing flow creates the data processing flow in Step 1020, instructs the execution, and the data processing flow 120 reaches the data processing execution environment 130.

When the data-processing flow editing screen 200 by the GUI as illustrated in FIG. 2 is available in the flow creation computer 110, it is possible to determine the access violation without waiting for the completion of data processing flow creation. For example, on the data-processing flow editing screen 200, the flow creator creates a flow by adding nodes to a data processing flow one by one (arranging nodes or connecting edges), and transmits the data processing flow being created to the access control unit 160 of the data management computer 300 for each creation work to determine whether or not there is an access violation. That is, the access violation for the added new node is determined at a timing when the new node is added to the data processing flow.

The data-processing-flow execution flow 1000 is repeated every time the flow is changed. When it is determined in Step 1030 that the access violation is included, the processing unit 310 in the data management computer 300 specifies a node to be added so that appropriate pre-processing is performed on the output of the node of the data processing flow in which it is determined that the access violation occurs. The node to be added refers to a node that performs pre-processing on the data attribute specified by the access control table 163 in Step 1034 in FIG. 10B. As described in Step 1050, a notification of the violation content and the resolution method is immediately performed on the data-processing flow editing screen 200.

In a fourth embodiment, no operation is performed in Step 1060, even though the access violation are not included, because the flow is still being created and not instructed to be executed.

The above-described procedure can be applied not only to the access determination but also to the optimization of the flow illustrated in the third embodiment. That is, it is possible to prompt early deletion of unnecessary data during creation of a flow.

According to the fourth embodiment, the access violation is appropriately detected and notified in the process of creating the data processing flow 120. Thus, it is possible to shorten the time for the flow creator to perform trial and error of the data processing, to the extent which is equal to or longer than that in the first embodiment.

### Fifth Embodiment

In the above embodiments, in Step 1030 of the data-processing-flow execution flow 1000, the structure of the data flowing in the flow and the calculation result of the pre-processing are not particularly saved after being generated for access right determination and optimization. In a fifth embodiment, the pieces of information are added to the calculation result of the data processing.

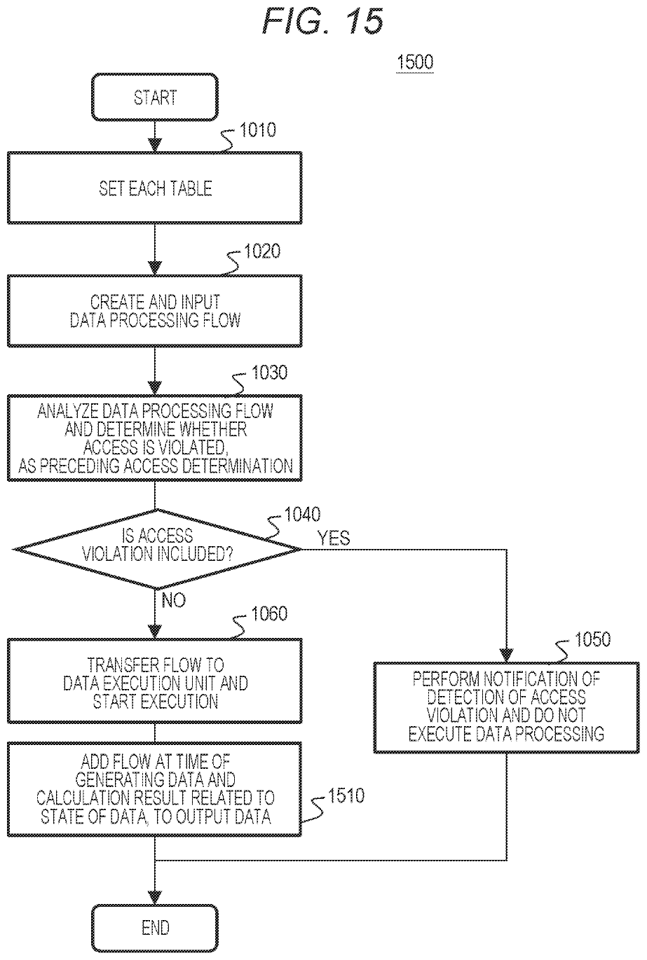

FIG. 15 illustrates a data-processing-flow execution flow 1500. In the data-processing-flow execution flow 1500, Step 1510 is inserted into the data-processing-flow execution flow 1000 after the execution of the data processing in Step 1060. In Step 1510, the data processing flow 120 executed in this flow is added to the output data in Step 1060 and saved in the memory 320 or a storage unit such as the data lake 180. In addition, the calculation result (for example, calculation result 1181 in the data processing flow 1160) in the last output of the flow is saved. The processing flow and the calculation result to be added and saved may be stored in the data lake 180 as metadata of output data of the processing flow, or may be saved by the data management unit 150 separately from the output data of the processing flow.

Several applications can be considered for the saved processing flow and calculation result.

One is that an execution status of pre-processing can be correctly taken over in data working across a plurality of processing flows. In the first embodiment, when the flow execution for a first processing flow is once ended, the execution status of the previous pre-processing is not left in the output data. In the fifth embodiment, since the calculation result is added to the output data, when the output data in the execution result of the first processing flow is set as input data of a second processing flow, the calculation result can be obtained by taking over the execution status of the pre-processing performed in the first processing flow, and thus it is possible to more accurately perform the access right determination.

Another application is that the processing flow and the calculation result added in this manner can be provided to other uses. For example, in a computer environment that handles information having high confidentiality, it is required to manage data generated by working and conversion, and to manage which original data the data has been derived from and processed through. The data processing flow just indicates the lineage of working, and it is useful for the history management to add the processing flow in data processing to data and make it possible to refer to the processing flow.

According to the fifth embodiment, it is possible to perform more accurate access determination and utilize an external function, by adding information regarding the processing flow and the structure and the attributes of the data to the output result of data processing execution.

As described above, it is possible to determine the access violation for the confidential information in advance before the service or the processing is executed, and thus to efficiently create a data processing flow in which the access violation does not occur.

In addition, it is possible to determine the access violation by using the information regarding the data structure and attributes included in the data lake.

by optimizing the data processing flow to delete unnecessary data early by using information regarding the data structure and attributes included in the data, it is possible to reduce the processing time and computer resources in execution of the data processing flow.

In addition, it is possible to appropriately detect an access violation in the process of creating the data processing flow.

Furthermore, by adding information regarding the processing flow, and the structure and attributes of data to the output result of data processing execution, it is possible to perform more accurate access determination and utilize an external function.

What is claimed is:

1. A data management computer that is connected to a flow creation computer that creates a data processing procedure as a data processing flow indicated by an arrangement of nodes that execute services, a data lake that stores various types of data, and a flow execution computer that executes the data processing flow, and detects an access violation of the data processing flow, the data management computer comprising:
a memory that stores an access control table for managing pre-processing to be executed for a data attribute of data of a data processing flow;
an interface that receives the data processing flow from the flow creation computer; and
a processing unit that
specifies a data attribute of output data of a first node indicated in the received data processing flow,
specifies pre-processing to be executed for the specified data attribute based on the specified data attribute and the access control table,
determines an access violation by comparing the specified pre-processing with a processing content of the data processing flow, and
performs control so as to transmit the data processing flow to the flow execution computer when there is no access violation, and
so as not to transmit the data processing flow to the flow execution computer when there is the access violation.

2. The data management computer according to claim 1, wherein
the memory stores, for the data of the data processing flow, a data attribute management table for managing a data type indicating an output format of data and a data attribute, and a service characteristic table for managing a characteristic of a service for the service, in addition to the access control table, and
the processing unit
specifies a service corresponding to the first node indicated in the received data processing flow,
specifies an output format of data of the first node based on the specified service and the service characteristic table,
specifies a data attribute of the output data from the first node based on the output format and the data attribute management table, and
specifies pre-processing for the specified data attribute based on the specified data attribute and the access control table.

3. The data management computer according to claim 2, wherein
when the access violation occurs, the processing unit transmits an analysis result that an output of the first node causes the access violation, to the flow creation computer.

4. The data management computer according to claim 2, wherein
the determination of the access violation by the processing unit is performed in accordance with a service execution place of a second node that is a next node of the first node in the data processing flow.

5. The data management computer according to claim 3, wherein
when determining that the access violation occurs, the processing unit specifies a service that executes the specified pre-processing, from the service characteristic table.

6. The data management computer according to claim 2, wherein
the data attribute management table stored in the memory is provided for managing data items indicating the data attribute and an information type, for the data type, and
the processing unit specifies a data attribute of output data of a node in the received data processing flow, based on an item of data in the data lake and the data items of the data attribute management table.

7. The data management computer according to claim 6, wherein
when data items in the data lake include a data item that is not used in a service executed by each node in the data processing flow, the processing unit specifies a node that executes a service of deleting the not-used data item and performs control so as to transmit the specified node to the flow creation computer.

8. The data management computer according to claim 5, wherein
when adding a node to the data processing flow, the processing unit determines the access violation for the data processing flow including the added new node.

9. The data management computer according to claim 8, wherein
when determining that an access right is violated, the processing unit specifies a node that executes the specified pre-processing.

10. The data management computer according to claim 5, further comprising:
a storage unit that stores the processing content of the data processing flow transmitted to the flow execution computer.

11. The data management computer according to claim 10, wherein
the processing unit stores, in the storage unit, information on a data type and pre-processing of a service executed by each node in the data processing flow.

12. A data management method of detecting an access violation of a data processing flow in a data management computer that is connected to a flow creation computer that creates a data processing procedure as a data processing flow indicated by an arrangement of nodes that execute services, a data lake that stores various types of data, and a flow execution computer that executes the data processing flow, the data management method comprising: by the data management computer,
storing an access control table for managing pre-processing to be executed for a data attribute for data of a data processing flow, in a memory;
receiving the data processing flow from the flow creation computer;
specifying a data attribute of output data of a specific node indicated in the received data processing flow;
specifying pre-processing to be executed for the data attribute based on the data attribute and the access control table;
determining an access violation by determining whether the specified pre-processing coincides with a processing content of the data processing flow; and
performing control so as to transmit the data processing flow to the flow execution computer when there is no access violation, and performing control so as not to transmit the data processing flow to the flow execution computer not to be performed when there is the access violation.

13. The data management method according to claim 12, further comprising:
storing, for the data of the data processing flow, a data attribute management table for managing a data type indicating an output format of data and a data attribute, and a service characteristic table for managing a characteristic of a service for the service, in addition to the access control table, in the memory;
wherein the data management computer specifies a service corresponding to a first node indicated in the received data processing flow;
specifies an output format of data from the first node based on the service characteristic table;
specifies a data attribute output from the first node based on the output format and the data attribute management table; and
specifies pre-processing for the data attribute based on the data attribute and the access control table.
